(19) United States
(12) Patent Application Publication
(10) Pub. No.: US 2004/0124764 A1
(43) Pub. Date: Jul. 1, 2004

(54) Light source device and display having the same

(75) Inventors: Toshihiro Suzuki, Kawasaki (JP); Tetsuya Kobayashi, Kawasaki (JP); Tetsuya Hamada, Kawasaki (JP); Keiji Hayashi, Kawasaki-shi (JP); Mari Sugawara, Kawasaki (JP)

Correspondence Address: GREER, BURNS & CRAIN, 300 S WACKER DR, 25TH FLOOR, CHICAGO, IL, 60606, US

(73) Assignee: FUJITSU DISPLAY TECHNOLOGIES CORP.

(21) Appl. No.: 10/691,461

(22) Filed: Oct. 22, 2003

(30) Foreign Application Priority Data
Oct. 25, 2002 (JP) 2002-311672

(51) Int. Cl. H05B 33/00

(52) U.S. Cl. 313/498; 313/110

(57) ABSTRACT

The invention relates to a light source device utilizing an array of discrete light sources and a display having the same and provides a small and thin light source device capable of achieving high display quality and a display having the same. A planar light guide plate is employed which has point light sources that emit light, a first light-emitting region provided in an area other than the neighborhood of one of the point light sources and having a first lighting element for taking out light guided from the side of the point light source, and a second light-emitting region provided in an area other than the neighborhood of the other point light source and having a second lighting element for taking out light guided from the side of the point light source.

### BACKGROUND OF THE INVENTION

1. Field of the Invention

The present invention relates to a light source device utilizing an array of discrete light sources and a display having the same.

2. Description of the Related Art

Cold-cathode tubes and light emitting diodes (LEDs) are used as light sources of liquid crystal displays. LEDs that can be made lightweight and compact are frequently used in relatively small liquid crystal displays. Since an LED is a point light source, it necessitates a structure for uniformly spreading light in a plane in order to achieve uniform illumination in a display screen.

Liquid crystal displays include front light type displays that are formed by a reflective liquid crystal display panel and a front light unit for illuminating the liquid display panel from a front side (display screen side) of the same and backlight type displays that are formed by a transmissive liquid crystal display panel and a backlight unit for illuminating the liquid crystal panel from a back side of the same.

For example, a common front light unit has an LED, a light guide plate (planar light guide plate) and a light guide pipe that is a rod-shaped light guide body. The light guide pipe is used to make emitting directions of light emitted by the LED that is a point light source uniform to provide a linear light source. The light transformed into a linear light source enters the light guide plate from a side thereof, and the light is uniformly guided in a plane to provide a planar light source. However, this configuration has problems in that the number of parts of a light source device will increase and in that it results in low efficiency and low luminance.

As a configuration that solves the above-described problems, a backlight unit is known in which a plurality of LEDs and a light-mixing region for mixing light rays from adjoining LEDs are both provided on a back side of a light guide plate and in which a semi-cylindrical curved mirror is provided at an end of the light guide plate to introduce the light mixed in the light-mixing region into the light guide plate (see Non-Patent Document 5, for example).

In a Japanese patent application (JP-A-2002-13766) made by the present applicant, a light source device is proposed in which a light -mixing region for mixing light rays from a plurality of LEDs is provided before a lighting area of a light guide plate.

When a dynamic image is displayed by a liquid crystal display that is a hold-type display system, the contour of the image can be blurred. Scan-type light source devices have been invented in which light sources are sequentially turned on in a region for which writing of tone data has already finished in order to suppress a blur on contours. Direct backlight type devices utilizing a cold-cathode tube have become the main stream of scan type light source devices. In such a direct type light source device, however, irregularity of luminance occurs depending on the arrangement of the cold-cathode tube, and a difficulty is encountered in achieving uniform luminance throughout a display area. In order to solve the problem, a side light type light source device is used which is a plurality of light-emitting regions formed by providing a plurality of LEDs on each of side end faces of a light guide plate, the light-emitting regions being provided side by side in a scanning direction of a liquid crystal display.

Patent Document 1: Japanese Patent Application Laid-Open No. JP-A-2000-3609

Non-Patent Document 1: J. Hirakata et al. “High Quality TFT-LCD System for Moving Picture”, SID 2002 Digest, pp. 1284-1287 (2002)

Non Patent Document 2: D. Sasaki et al. “Motion Picture Simulation for Designing High-Picture-Quality Hold-Type Displays”, SID 2002 Digest, pp. 926-929 (2002)

Non-Patent Document 3: K. Sekiya et al. “Eye-Trace Integration Effect on The Perception of Moving Pictures and A New Possibility for Reducing Blur on Hold-Type Displays”, SID 2002 Digest, pp. 930-933 (2002)

Non-Patent Document 4: H. Ohtsuki et al. “18.1-inch XGA TFT-LCD with Wide Color Reproduction using High Power LED-Backlighting”, SID 2002 Digest, pp. 1154-1157 (2002)

Non-Patent Document 5: Gerald Harbers and two others, “LED Backlighting for LCD-HDTV, [online], internet <URL: http://www.lumileds.com/pdfs/techpaperspres/IDMC_Paper.pdf>

Non-Patent Document 6: T. Kurita “Display Method for Hold-Type Displays and Picture Quality of Moving Picture Display”, a draft for the 1st LCD Forum

However, the light source device having a light-mixing region has a problem in that the light source device is large-sized because it requires a light-mixing region having an area much greater than a minimum area that a point light source device must have to allow display to be performed. A configuration in which a light-mixing region is provided on a back side of a light guide plate also results in the problem of an increase in the size of a light source device because the thickness of the same is increased.

On the contrary, in a scan type light source device which has no light-mixing region and in which a plurality of LEDs are provided on side end faces of a light guide plate, the luminance of regions between adjoining LEDs becomes lower than that of other regions because the LEDs provided side by side are an array of discrete light sources. This results in a problem in that display quality is reduced by the occurrence of irregularities of luminance on the display screen.

### SUMMARY OF THE INVENTION

It is an object of the invention to provide a light source device which is compact and thin and which provides high display quality and to provide a display having the same.

The above object is achieved by a light source device, characterized in that it has first and second light sources which emits light and a planar light guide plate having a first light-emitting region which is provided in an area other than the neighborhood of the first light source and which has a first lighting element for taking out light guided from the side of the first light source and a second light-emitting region which is provided in an area other than the neighborhood of the second light source and which has a second lighting element for taking out light guided from the side of the second light source.

### BRIEF DESCRIPTION OF THE DRAWINGS

FIG. 1 shows a configuration of a liquid crystal display according to a basic configuration in a first mode for carrying out the invention;

FIGS. 2A and 2B show a configuration of a light source device according to the basic configuration in the first mode for carrying out the invention;

FIG. 3 is a sectional view showing a configuration of a light source device according to Embodiment 1-1 in the first mode for carrying out the invention;

FIGS. 4A to 4E are sectional views showing a configuration of the light source device according to Embodiment 1-1 in the first mode for carrying out the invention;

FIG. 5 is a sectional view showing a configuration of a light source device according to Embodiment 1-2 in the first mode for carrying out the invention;

FIG. 6 is a sectional view showing a configuration of a light source device according to Embodiment 1-3 in the first mode for carrying out the invention;

FIG. 7 is a sectional view showing a configuration of a light source device according to Embodiment 1-4 in the first mode for carrying out the invention;

FIG. 8 is a sectional view showing a configuration of a light source device according to Embodiment 1-5 in the first mode for carrying out the invention;

FIG. 9 is a sectional view showing a configuration of a light source device according to Embodiment 1-6 in the first mode for carrying out the invention;

FIG. 10 is a graph showing distributions of intensities of scattering and quantities of light in the light guide plate of the light source device according to Embodiment 1-6 in the first mode for carrying out the invention;

FIG. 11 is a sectional view showing a configuration of a light source device according to a modification of Embodiment 1-6 in the first mode for carrying out the invention;

FIG. 12 is a graph showing distributions of intensities of scattering and quantities of light in the light guide plate of the light source device according to the modification of Embodiment 1-6 in the first mode for carrying out the invention;

FIG. 13 is a sectional view showing a configuration of a liquid crystal display according to Embodiment 1-7 in the first mode for carrying out the invention;

FIG. 14 is a sectional view showing a configuration of a liquid crystal display according to Embodiment 1-8 in the first mode for carrying out the invention;

FIGS. 15A and 15B are sectional views showing a configuration of a light source device according to Embodiment 1-9 in the first mode for carrying out the invention;

FIG. 16 is a sectional view showing a configuration of a light source device according to Embodiment 2-1 in a second mode for carrying out the invention;

FIG. 17 is a block diagram showing a configuration of a liquid crystal display according to Embodiment 2-2 in the second mode for carrying out the invention;

FIG. 18 is a sectional view showing a configuration of the liquid crystal display according to Embodiment 2-2 in the second mode for carrying out the invention;

FIG. 19 is a sectional view showing a configuration of a light source device according to Embodiment 2-2 in the second mode for carrying out the invention;

FIG. 20 illustrates a method for driving the liquid crystal display according to Embodiment 2-2 in the second mode for carrying out the invention;

FIG. 21 is a block diagram showing a modification of the configuration of a liquid crystal display according to Embodiment 2-2 in the second mode for carrying out the invention;

FIG. 22 is a sectional view showing a modification of the configuration of the light source device according to Embodiment 2-2 in the second mode for carrying out the invention;

FIG. 23 is a sectional view showing a configuration of a liquid crystal display according to Embodiment 2-3 in the second mode for carrying out the invention;

FIG. 24 is a sectional view showing a configuration of a liquid crystal display according to Embodiment 2-4 in the second mode for carrying out the invention;

FIG. 25 is a sectional view showing a configuration of a light source device according to Embodiment 2-4 in the second mode for carrying out the invention; and

FIG. 26 illustrates a method for driving the light source device according to Embodiment 2-4 in the second mode for carrying out the invention.

### DESCRIPTION OF THE PREFERRED EMBODIMENTS

### First Mode for Carrying Out the Invention

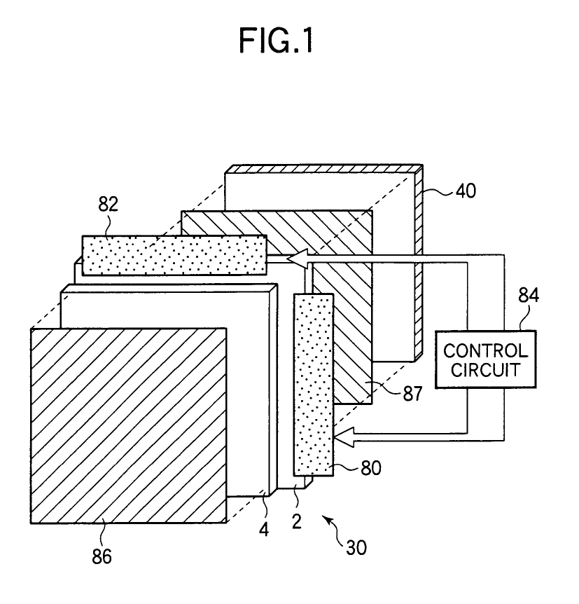

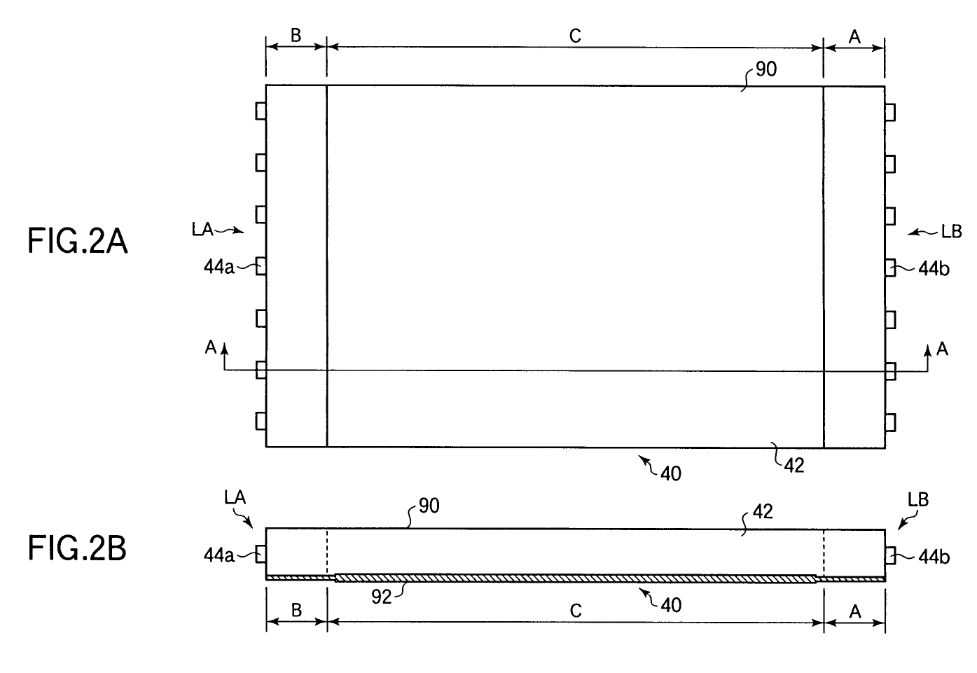

A description will now be made with reference to FIGS. 1 to 15B on a light source device and a display having the same in a first mode for carrying out the invention. First, a basic configuration for the light source device and the display having the same in the present mode for carrying out the invention will be described with reference to FIGS. 1 to 2B. FIG. 1 shows a schematic configuration of a liquid display device according to the basic configuration. As shown in FIG. 1, for example, a TN (twisted nematic) mode liquid crystal display has a liquid crystal display panel 30 which is formed by combining a TFT substrate 2 having thin film transistors (TFTs) and pixel electrodes formed thereon and an opposite substrate 4 having color filters and a common electrode formed thereon in a face-to-face relationship and sealing a liquid crystal (not shown) between the substrates 2 and 4.

A gate bus line driving circuit 80 loaded with driver ICs for driving a plurality of gate bus lines and a drain bus line driving circuit 82 loaded with driver ICs for driving a plurality of drain bus lines are provided on the TFT substrate 2. The driving circuits 80 and 82 output scan signals or data signals to predetermined gate bus lines 12 or drain bus lines 14 based on predetermined signals output from a control circuit 84. A polarizer 87 is applied to a surface of the TFT substrate 2 that is opposite to the surface of the same where the elements are formed. A backlight unit that is a light source device 40 is provided on a surface of the polarizer 87 that is opposite to the surface of the same facing the TFT substrate 2. On the contrary, a polarizer 86 is applied to a surface of the opposite substrate 4 that is opposite to the surface of the same where the color filters are formed.

FIG. 2A shows a configuration of the light source device according to the present basic configuration. FIG. 2B shows a sectional configuration of the light source device taken along the line A-A in FIG. 2A. As shown in FIGS. 2A and 2B, the light source device 40 that is used as a backlight unit or a front light unit has a substantially plate-like light guide (planar light guide plate) 42. For example, the light guide plate 42 has a rectangular planer shape. A top surface of the light guide plate 42 (the upper side in FIG. 2B) constitutes a light exit surface 90. For example, a plurality of point light sources 44a constituting an array of discrete light sources LA are provided side by side at predetermined intervals on one side end face of the light guide plate 42 (a left side end face in FIGS. 2A and 2B). For example, a plurality of point light sources 44b constituting an array of discrete light sources LB are provided side by side at predetermined intervals on another side end face of the light guide plate 42 (a right side end face in FIGS. 2A and 2B) in a face-to-face relationship with the discrete light source array LA. The light guide plate 42 has a region B in the vicinity of the point light sources 44a, a region A in the vicinity of the point light sources 44b, and a region C between the regions A and B.

Light from the point light sources 44a has very strong hysteresis of the discreteness of the discrete light source array LA immediately after it enters the region B of the light guide plate 42, which results in irregularities in the distribution of the quantity of light that is guided. In the region B, light rays from a pair of adjoining point light sources 44a are more apt to be mixed with each other and even with light rays from other adjacent point light sources 44a, the further their positions from the discrete light source array LA, which results in a uniform distribution of the quantity of light guided in that region. Similarly, light from the point light sources 44b has very strong hysteresis of the discreteness of the discrete light source array LB immediately after it enters the region A of the light guide plate 42, which results in irregularities in the distribution of the quantity of light that is guided. In the region A, light rays from a pair of adjoining point light sources 44b are more apt to be mixed with each other and even with light rays from other adjacent point light sources 44b, the further their positions from the discrete light source array LB, which results in a uniform distribution of the quantity of light guided in that region. In the region C, the quantity of light guided from the discrete light source array LA is uniformly distributed. In the region C, the quantity of light guided from the discrete light source array LB is also uniformly distributed.

Although not shown in FIGS. 2A and 2B, the light guide plate 42 has lighting elements, provided on a surface 92 opposite to the light exit surface 90, for causing light incident thereon to exit the light exit surface 90. The lighting elements are provided such that the quantity of light taken out on the display screen side becomes uniform in the plane. Specifically, lighting elements for primarily taking light guided from the side of the discrete light source array LB out of the light guide plate 42 are provided in the region B of the light guide plate 42 that is near the discrete light source array LA. In addition, the region B is used for mixing light rays guided from the side of the discrete light source array LA. The light rays guided from the side of the discrete light source array LB include not only light rays directly emitted by the point light sources 44b but also reflected light rays which have been emitted by the point light sources 44a and reflected on the side end face of the light guide plate 42 where the point light sources 44b are provided. The light rays guided from the side of the discrete light source array LA include not only light rays directly emitted by the point light sources 44a but also reflected light rays which have been emitted by the point light sources 44b and reflected on the side end face of the light guide plate 42 where the point light sources 44a are provided.

Similarly, lighting elements for primarily taking light guided from the side of the discrete light source array LA out of the light guide plate 42 are provided in the region A of the light guide plate 42 that is near the discrete light source array LB. In addition, the region A is used for mixing light rays guided from the side of the discrete light source array LB. In the region C near the center of the light guide plate 42, lighting elements are provided to take both of the light rays guided from the side of the discrete light source array LA and the light rays guided from the side of the discrete light source array LB out of the light guide plate 42.

The light rays from the point light sources 44a of the discrete light source array LA and the light rays from the point light sources 44b of the discrete light source array LB are frequently in different colors. Therefore, when an abrupt change occurs in a spatial mixing ratio between the light rays from the discrete light source arrays LA and LB, a color irregularity in the form of a band can be visually perceived. In order to avoid this, the boundaries between the regions B and C and between the regions A and C are preferably distributed gently rather than being clearly defined.

The lighting elements used may be light-scattering elements such as light-scattering structures formed through printing or molding on an opposite surface 92 of the light guide plate 42, prism-like features formed on the opposite surface of the light guide plate 42, or light-scattering elements formed in the light guide plate 42. Alternatively, any optical element that changes the direction in which light is guided may be used as the lighting element.

In the present basic configuration, the discrete light source array LA and the regions A and C (a first light-emitting region) for taking out light rays from the side of the discrete light source array LA are spaced from each other a relatively great distance, and the discrete light source array LB and the regions B and C (a second light-emitting region) for taking out light rays from the side of the discrete light source array LB are spaced from each other a relatively great distance. Therefore, the light rays exit the light exit surface 90 after being sufficiently mixed to distribute the quantity of the guided light uniformly, which makes it possible to provide a light source device that achieves high display quality without irregularities of luminance and color. In the present basic configuration, the point light sources 44a are provided near the region B of the light guide plate 42, and the point light sources 44b are provided near the region A of the light guide plate 42. This makes it possible to provide a small and thin light source device.

Light source devices and displays having the same in the present mode for carrying out the invention will now be specifically described with reference to Embodiments 1-1 to 1-9.

### Embodiment 1-1

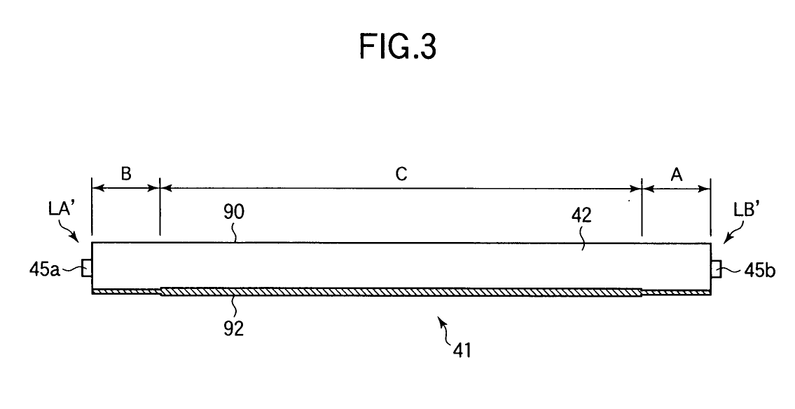

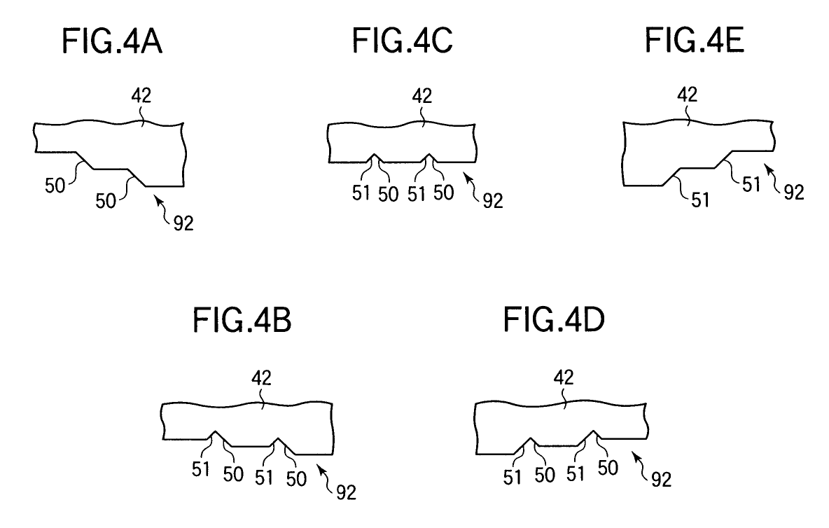

First, a light source device according to Embodiment 1-1 in the present mode for carrying out the invention will be described with reference to FIGS. 3 to 4E. FIG. 3 shows a sectional configuration of the light source device of the present embodiment. As shown in FIG. 3, a backlight unit 41 that is a light source device has a light guide plate 42. An opposite surface 92 of the light guide plate 42 is formed as a prism-like feature. The prism-like feature functions as a lighting element for taking out light. In the present embodiment, all lighting elements are prism-like features. A plurality of LEDs 45a constituting an LED array LA′ that is an array of discrete light sources are provided side by side on one side end face (a left side end face in FIG. 3) of the light guide plate 42. A plurality of LEDs 45b constituting an LED array LB′ that is an array of discrete light sources are provided side by side on another side end face (a right side end face in FIG. 3) of the light guide plate 42 in a face-to-face relationship with the LED array LA′. The light guide plate 42 has a region B in the vicinity of the LEDs 45a, a region A in the vicinity of the LEDs 45b, and a region C between the regions A and B.

FIGS. 4A to 4E show sectional configurations of respective regions of the light guide plate in the vicinity of the opposite surface. FIG. 4A shows a sectional configuration of the light guide plate 42 in the vicinity of the opposite surface 92 in the region B. FIG. 4B shows a sectional configuration of the light guide plate 42 in the vicinity of the opposite surface 92 in a part of the region C adjacent to the region B. FIG. 4C shows a sectional configuration of the light guide plate 42 in the vicinity of the opposite surface 92 substantially in the middle of the region C. FIG. 4D shows a sectional configuration of the light guide plate 42 in the vicinity of the opposite surface 92 in a part of the region C adjacent to the region A. FIG. 4E shows a sectional configuration of the light guide plate 42 in the vicinity of the opposite surface 92 in the region A. As shown in FIGS. 4A to 4E, the opposite surface 92 of the light guide plate 42 is formed with prism-like features that are generally categorized into five types depending on their distances from the LED arrays LA′ and LB′.

As shown in FIG. 4A, the opposite surface 92 in the region B is in the form of such prisms that light rays from the side of the LED array LA′ are directly guided to the region C without impinging on prism surfaces 50. The prism surfaces 50 are formed at an inclination in the range from 40° to 45° to a light exit surface 90, for example. On the contrary, light rays from the side of the LED array LB′ impinge on the prism surfaces 50 with certain probabilities. The light rays incident on the prism surfaces 50 exit the light guide plate 42 as a result of reflection or refraction because the condition for total reflection is unsatisfied. Therefore, light rays guided from the side of the LED array LB′ are basically taken out in the region B. The light rays guided from the side of the LED array LB′ include not only light rays directly emitted by the LEDs 45b but also reflected light rays which have been emitted by the LEDs 45a and reflected on the side end face of the light guide plate 42 where the LEDs 45b are provided.

As shown in FIGS. 4B to 4D, in the region C, light rays guided from the side of the LED array LA′ impinge on the prism surfaces 50 with certain probabilities and exit the light guide plate 42 as a result of reflection or refraction. The light rays guided from the side of the LED array LA′ include not only light rays directly emitted by the LEDs 45a but also reflected light rays which have been emitted by the LEDs 45b and reflected on the side end face of the light guide plate 42 where the LEDs 45a are provided. In the region C, light rays guided from the side of the LED array LB′ impinge on prism surfaces 51 with certain probabilities and exit the light guide plate 42 as a result of reflection or refraction. The prism surfaces 51 are formed at an inclination in the range from 40° to 45° to the light exit surface 90. As shown in FIG. 4B, in the part of the region C adjacent to the region B, a majority of the quantity of light is guided from the side of the LED array LA′, and the area of the prism surfaces 51 on which the light rays from the side of the LED array LA′ impinge is made smaller than the area of the prism surfaces 50 on which light rays from the side of the LED array LB′ impinge in order to make the boundary between the regions B and C less visually perceptible.

As shown in FIG. 4C, the quantity of light guided from the side of the LED array LA′ and the quantity of light guided from the side of the LED array LB′ are substantially equal to each other in a part that is substantially in the middle of the region C. The areas of the prism surfaces 50 and 51 are made substantially equal to each other to provide a prism-like feature that is substantially laterally symmetric. As shown in FIG. 4D, in the part of the region C adjacent to the region A, a majority of the quantity of light is guided from the side of the LED array LB′, and the area of the prism surfaces 50 on which the light rays from the side of the LED array LB′ impinge is made smaller than the area of the prism surfaces 51 on which light rays from the side of the LED array LA′ impinge in order to make the boundary between the regions A and C less visually perceptible.

As shown in FIG. 4E, the opposite surface 92 in the region A is in the form of such prisms that light rays from the side of the LED array LB′ are directly guided to the region C without impinging on prism surfaces 51. On the contrary, light rays from the side of the LED array LA′ impinge on the prism surfaces 51 with certain probabilities. The light rays incident on the prism surfaces 51 exit the light guide plate 42 as a result of reflection or reflection because the condition for total reflection is unsatisfied. Therefore, the light rays guided from the side of the LED array LA′ are basically taken out in the region A. As described above, the light guide plate 42 has a sectional shape that is substantially laterally symmetric.

In the present embodiment, the LED array LA′ and the regions A and C (a first light-emitting region) from which light rays from the side of the LED array LA′ are taken out are spaced from each other a relatively great distance, and the LED array LB′ and the regions B and C (a second light-emitting region) from which light rays from the side of the LED array LB′ are taken out are spaced from each other a relatively great distance. Since the light rays thus exit the light exit surface 90 after being sufficiently mixed to distribute the quantity of the guided light uniformly, it is possible to provide a light source device that can achieve high display quality without irregularities of luminance and color. Further, in the present embodiment, the LEDs 45a are provided near the region B of the light guide plate 42, and the LEDs 45b are provided near the region A of the light guide plate 42. This makes it possible to provide a small and thin light source device.

### Embodiment 1-2

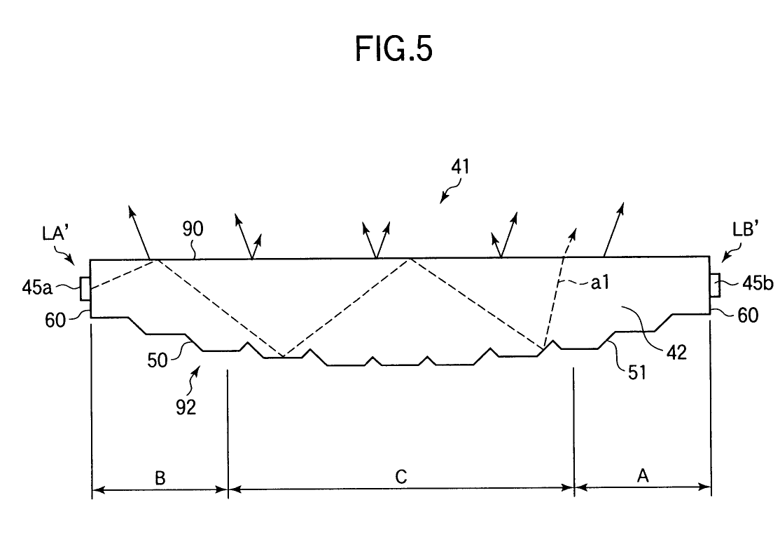

A light source device according to Embodiment 1-2 in the present mode for carrying out the invention will now be described with reference to FIG. 5. FIG. 5 shows a sectional configuration of the light source device of the present embodiment. As shown in FIG. 5, a backlight unit 41 has a light guide plate 42. The light guide plate 42 has a rectangular lighting area of 385 mm×250 mm, for example. The thickness of the light guide plate 42 is about 7 mm in the vicinity of side end faces thereof (both side end faces in FIG. 5) and about 9 mm in the vicinity of the center of the same. LED arrays LA′ and LB′ are provided in the vicinity of longer sides of the light guide plate 42 opposite to each other. That is, the horizontal direction of the FIG. 5 corresponds to the vertical direction of a display screen that is longer in the horizontal direction, for example. The LED arrays LA′ and LB′ are constituted by 22 each high power LEDs 45a and 45b, respectively, which are provided at intervals of 17.5 mm, for example.

Mirrors 60 as light-reflecting elements for reflecting light rays are formed inside or outside the side end faces of the light guide plate 42 where the LED arrays LA′ and LB′ are provided. About 30% of light rays emitted by the LED array LA′ (LB′) reach the opposite side end face where the LED array LB′ (LA′) is provided. About half of the light rays thus reached (about 15% of the light rays emitted by the LED array LA′ (LB′)) are reflected by the mirror 60 and made effective light rays. Since the light rays emitted by the LED array LA′ (LB′) and the light rays guided from the LED array LB′ (LA′) and thus reflected are mixed with each other, color irregularities attributable to spectral irregularities between the LED arrays LA′ and LB′ are mitigated.

The arrow indicated by a broken line in the figure represents a light ray a1 that is an example of the light rays emitted by the LEDs 45a and guided in the light guide plate 42. The light ray a1 impinges on the light guide plate 42 and undergoes total reflection at a light exit surface 90, and the light ray thereafter undergoes total reflection at an opposite surface 92 in a part of a region C adjacent to a region B without impinging on prism surfaces 50 and 51. Then, after being subjected to total reflection at the light exit surface 90 again, the light ray impinges on a prism surface 51 of the opposite surface 92 in a part of the region C adjacent to a region A and is reflected by the surface. The light ray a1 reflected by the prism surface 51 exits the light exit surface 90 where the condition for total reflection is unsatisfied.

The arrows indicated by solid lines outside the light exit surface 90 in the figure represent directions in which light rays exit the surface and the intensities of the same. As illustrated, light rays from the side of the LED array LB′ exit in the region B, and light rays from the side of the LED array LA′ exit in the region A. While both of light rays from the side of the LED array LA′ and light rays from the side of the LED array LB′ exit in the region C, light rays from the side of the LED array LA′ exit with higher intensities in a part of the same region adjacent to the region A, and light rays from the side of the LED array LB′ exit with higher intensities in a part of the same region adjacent to the region B. The sum of the intensities of light rays from the side of the LED array LA′ and the intensities of light rays from the side of the LED array LB′ is substantially the same in all of the regions.

In the configuration of the present embodiment, neither luminance irregularity nor color irregularity was visually perceived when the width of each of the regions A and B was about 40 mm and the width of the region C was about 170 mm. The quantity of light emitted by each of the LEDs 45a and LEDs 45b is 151 m (lumens), and the backlight unit 41 provided a white intensity of 400 cd (candles). Similarly to Embodiment 1-1, the present embodiment makes it possible to provide a light source device which is small and thin and which can achieve high display quality without irregularities of luminance and color.

### Embodiment 1-3

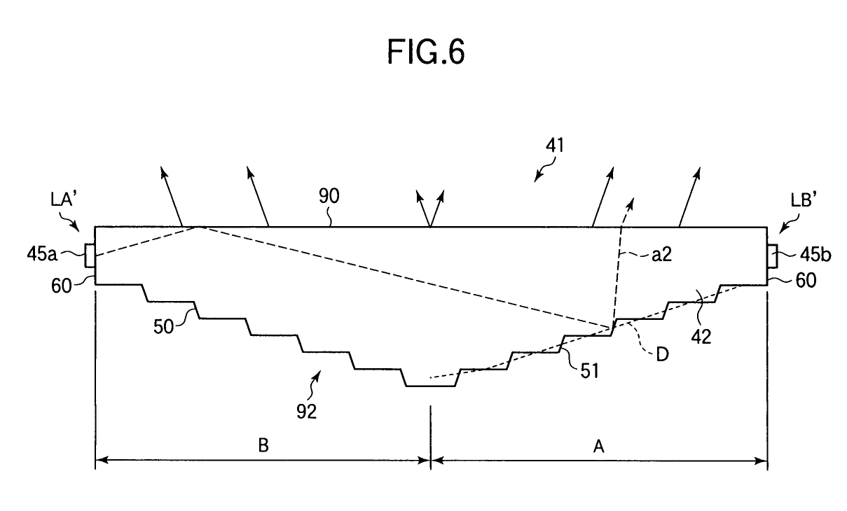

A light source device according to Embodiment 1-3 in the present mode for carrying out the invention will now be described with reference to FIG. 6. FIG. 6 shows a sectional configuration of the light source device of the present embodiment. As shown in FIG. 6, in comparison to the backlight unit 41 of Embodiment 1-2, a backlight unit 41 of the present embodiment is characterized in that a region for taking out light rays from the side of an LED array LA′ is separated from a region for taking out light rays from the side of an LED array LB′. Therefore, the lighting area of the embodiment has only the regions A and B and does not have a region C for taking light rays from both of the LED arrays LA′ and LB′. The backlight unit 41 of the present embodiment is also characterized in that the LED array LA′ and the region A is further away from each other and the LED array LB′ and the region B are also further away from each other.

The arrow indicated by a broken line in the figure represents a light ray a2 that is an example of the light rays emitted by the LEDs 45a and guided in the light guide plate 42. The light ray a2 impinges on the light guide plate 42 and undergoes total reflection at a light exit surface 90, and the light ray thereafter impinges on a prism surface 51 of an opposite surface 92 in the region A and is reflected by the surface. The light ray a2 reflected by the prism surface 51 exits the light exit surface 90 where the condition for total reflection is unsatisfied.

The light guide plate 42 has a rectangular lighting area of 385 mm×250 mm, for example. The thickness of the light guide plate 42 is about 7 mm in the vicinity of side end faces thereof and about 17 mm in the vicinity of the center of the same. For example, a datum plane D of the opposite surface 92 of the light guide plate 42 is downwardly displaced by a quantity 1/x in the figure where x represents the distance of the same from the LED array LB′. The LED arrays LA′ and LB′ are provided in the vicinity of longer sides of the light guide plate 42 opposite to each other. That is, the horizontal direction of the FIG. 6 corresponds to the vertical direction of a display screen that is longer in the horizontal direction, for example. The LED arrays LA′ and LB′ are constituted by 22 each high power LEDs 45a and 45b, respectively, which are provided at intervals of 17.5 mm, for example.

About 40% of light rays emitted by the LED array LA′ (LB′) reach the opposite side end face where the LED array LB′ (LA′) is provided. About half of the light rays thus reached (about 20% of the light rays emitted by the LED array LA′ (LB′)) are reflected by the mirror 60 and made effective light rays. As a result, the light rays from the LED array LA′ and the light rays from the LED array LB′ are satisfactorily mixed throughout the lighting area in spite of the absence of the region C. In the present embodiment, no irregularity of luminance or color was visually perceived even when about 5 out of the 22 LEDs 45a (LEDs 45b) provided on either side end face of the light guide plate 42 did not turn on.

According to the present embodiment, excellent mixing of light rays can be achieved to provide a light source device that can achieve high display quality, although the light guide plate 42 is thicker than that in the light source device of Embodiment 1-2.

### Embodiment 1-4

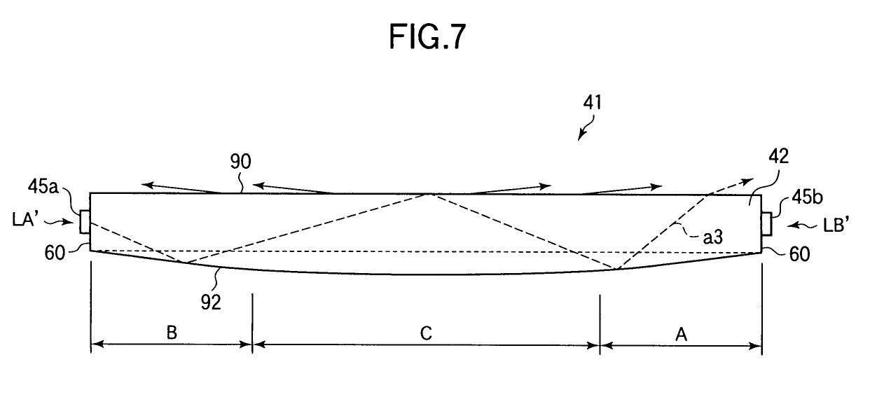

A light source device according to Embodiment 1-4 in the present mode for carrying out the invention will now be described with reference to FIG. 7. FIG. 7 shows a sectional configuration of the light source device of the present embodiment. As shown in FIG. 7, a backlight unit 41 of the present embodiment has a light guide plate 42 having an opposite surface 92 that is cylindrically curved. A side of the light guide plate 42 where an LED array LA′ is provided is formed in a configuration in which the thickness of the plate is smaller at the side end face and becomes greater in a central part of the same (the configuration being sometimes referred to as “wedge-like feature” in the present specification). Similarly, a side of the light guide plate 42 where an LED array LB′ is provided is formed in a configuration in which the thickness of the plate is smaller at the side end face and becomes greater in the central part of the same. Further, fine irregularities are formed on the curved opposite surface 92. For example, the irregularities are fine structures which are provided at intervals of 1 mm or less and which gently meander at a maximum inclination of a few degrees or less to the opposite surface 92. The light guide plate 42 is made of acrylic, for example.

In a region B and in a part of a region C adjacent to the region B, the scattering angle of light rays from LEDs 45a, which has been 42° immediately after the light rays were emitted to impinge on the light guide plate 42, does not increase so much because the effect of scatter reflections attributable to the fine irregularities is cancelled by a converging effect of the wedge-like feature in which the thickness of the light guide plate 42 gradually increases with respect to those light rays. Therefore, substantially none of the light rays from the LEDs 45a is taken out from the light guide plate 42 in the region B. In the region B and in the part of the region C adjacent to the region B, a light-scattering effect is exerted on light rays guided from the side of the LEDs 45b by both of the fine irregularities and the wedge-like feature in which the thickness of the light guide plate 42 gradually decreases with respect to those light rays. Light rays in a region are therefore taken out with higher efficiency, the smaller the distance of the region to the LED array LA′. As a result, the sum of the intensities of light rays guided from the side of the LED array LA′ and taken out in the region B and the part of the region C adjacent to the region B and the sum of the intensities of light rays guided from the side of the LED array LB′ and taken out in those regions are substantially equal.

On the contrary, in a region A and in a part of the region C adjacent to the region A, the scattering angle of light rays from LEDs 45b, which has been 420 immediately after the light rays were emitted to impinge on the light guide plate 42, does not increase so much because the effect of scatter reflections attributable to the fine irregularities is cancelled by a converging effect of the wedge-like feature in which the thickness of the light guide plate 42 gradually increases with respect to those light rays. Therefore, substantially none of the light rays from the LEDs 45b is taken out from the light guide plate 42 in the region A. In the region A and in the part of the region C adjacent to the region A, a light-scattering effect is exerted on light rays guided from the side of the LEDs 45a by both of the fine irregularities and the wedge-like feature in which the thickness of the light guide plate 42 gradually decreases with respect to those light rays. Light rays in a region are therefore taken out with higher efficiency, the smaller the distance of the region to the LED array LB′. As a result, the sum of the intensities of light rays guided from the side of the LED array LA′ and taken out in the region A and the part of the region C adjacent to the region A and the sum of the intensities of light rays guided from the side of the LED array LB′ and taken out in those regions are substantially equal.

The arrow indicated by a broken line in the figure represents a light ray a3 that is an example of the light rays emitted by the LEDs 45a and guided in the light guide plate 42. The light ray a3 impinges on the light guide plate 42 and undergoes total reflection at the opposite surface 92 in the region B, and it thereafter undergoes total reflection at the light exit surface 90. Thereafter, the light ray a3 is reflected by the opposite surface 92 in the region A. After being reflected by the opposite surface 92 in the region A, the angle of incidence of the light ray a3 on the light exit surface 90 is reduced by the wedge-like feature in which the thickness of the light guide plate 42 gradually decreases. Thus, the light ray exits the light exit surface 90 because the condition for total reflection is unsatisfied.

Similarly to Embodiment 1-1, the present embodiment makes it possible to provide a light source device which is small and thin and which can achieve high display quality without irregularities of luminance and color.

### Embodiment 1-5

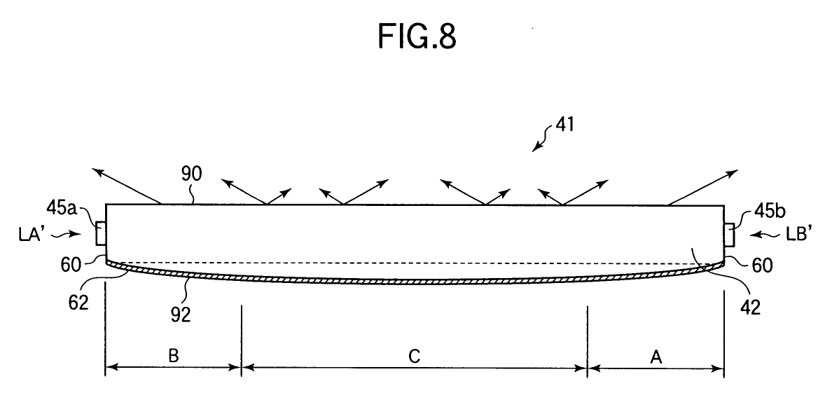

A light source device according to Embodiment 1-5 in the present mode for carrying out the invention will now be described with reference to FIG. 8. FIG. 8 shows a sectional configuration of the light source device of the present embodiment. As shown in FIG. 8, a backlight unit 41 of the present embodiment has a light guide plate 42 having an opposite surface 92 that is cylindrically curved, similarly to the backlight unit 41 of Embodiment 1-4. A scattering layer 62 that is a light-scattering element is formed on the opposite surface 92 using, for example, screen printing instead of the fine irregularities in Embodiment 1-4.

Similarly to Embodiment 1-1, the present embodiment makes it possible to provide a light source device which is small and thin and which can achieve high display quality without luminance and color irregularities. The backlight unit 41 of the present embodiment allows excellent mixing of light rays, although it has a problem in that a scattering sheet must be provided on the display screen side of the light guide plate 42 because it is difficult to finely process compared to that in Embodiment 1-4. Further, since the backlight unit 41 of the present embodiment requires no fine irregularity to be formed on the opposite surface 92, a die for molding the light guide plate 42 will have a long life, and manufacturability will be excellent because high printing accuracy is not required.

### Embodiment 1-6

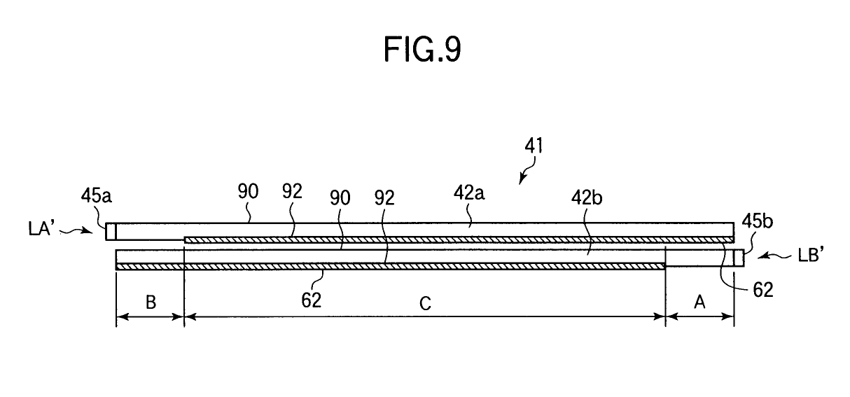

A light source device according to Embodiment 1-6 in the present mode for carrying out the invention will now be described with reference to FIGS. 9 to 12. FIG. 9 shows a sectional configuration of the light source device of the present embodiment. As shown in FIG. 9, a backlight unit 41 of the present embodiment has two light guide plates 42a and 42b that are stacked one on the other. A plurality of LEDs 45a constituting an LED array LA′ are provided side by side on one side end face of the light guide plate 42a (a left side end face in FIG. 9). A scattering layer 62 that is a light-scattering element is formed on an opposite surface 92 of the light guide plate 42a using screen printing, for example. The light-scattering layer 62 of the light guide plate 42a is not formed in a region B located in the vicinity of the LED array LA′ and is formed in regions A and C. For example, the light scattering layer 62 is made of a resin containing beads and is formed with a predetermined a real gradient. The light guide plate 42a has a light guide area for guiding light rays from the LEDs 45a to the regions A and C.

A plurality of LEDs 45b constituting an LED array LB′ are provided side by side one side end face of the light guide plate 42b (a right side end face in FIG. 9). A scattering layer 62 that is a light-scattering element is formed on an opposite surface 92 of the light guide plate 42b using screen printing, for example. The light-scattering layer 62 of the light guide plate 42b is not formed in the region A located in the vicinity of the LED array LB′ and is formed in the regions B and C. The light guide plate 42b has a light guide area for guiding light rays from the LEDs 45b to the regions B and C. The light guide plates 42a and 42b are manufactured such that uniform luminance is achieved throughout a display area when they are stacked.

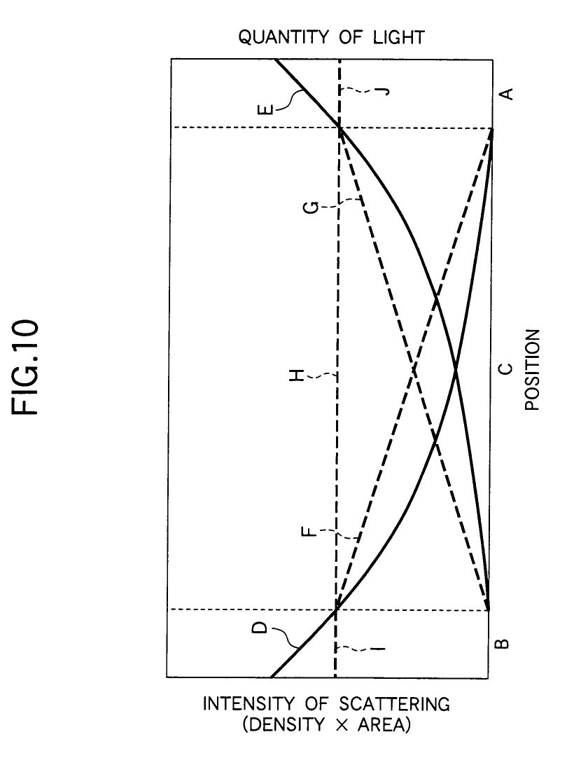

FIG. 10 is a graph showing distributions of intensities of scattering and quantities of light in the light guide plate of the present embodiment. The abscissa axis represents distances (positions) from the LED array LA′, and the ordinate axis represents intensities of scattering and quantities of light in the scattering layers 62. The intensities of scattering are represented by the products of the densities of the beads in the scattering layers 62 and the a real gradients. The solid line D in the graph represents the intensity of scattering in the scattering layer 62 of the light guide plate 42b, and the solid line E represents the intensity of scattering in the scattering layer 62 of the light guide plate 42a. The broken lines I and F represent the quantity of light that exits the light guide plate 42a, and the broken lines G and J represent the quantity of light that exits the light guide plate 42b. The broken lines I, H and J represent the sum of the quantity of light that exits the light guide plate 42a and the quantity of light that exits the light guide plate 42b.

As shown in FIG. 10, the quantity of light exiting the light guide plate 42a is made constant in the region B by forming the scattering layer 62 of the light guide plate 42a so that it has the scattering intensity distribution indicated by the solid line E. In the region C, the quantity of light exiting the light guide plate 42a decreases in proportion to the distance from the boundary between the regions B and C and reaches 0 at the boundary between the regions A and C. The quantity of light exiting the light guide plate 42b is made constant in the region A by forming the scattering layer 62 of the light guide plate 42b so that it has the scattering intensity distribution indicated by the solid line D. In the region C, the quantity of light exiting the light guide plate 42b decreases in proportion to the distance from the boundary between the regions A and C and reaches 0 at the boundary between the regions B and C. By distributing the quantities of light exiting the light guide plates 42a and 42b in such a manner, the sum of the quantity of light exiting the light guide plate 42a and the quantity of light exiting the light guide plate 42b is made substantially constant in a plane as indicated by the broken lines I, H and J.

While the scattering layer 62 are used as lighting elements in the present embodiment, prism-like features on the light guide plates 42a and 42b may alternatively be used, and the prism-like features may be used in combination with the scattering layers 62. The present embodiment makes it possible to provide a light source device that can achieve high display quality without irregularities of luminance and color just as in Embodiment 1-1, although the backlight unit has a great thickness to allow the light guide plates 42a and 42b to be stacked.

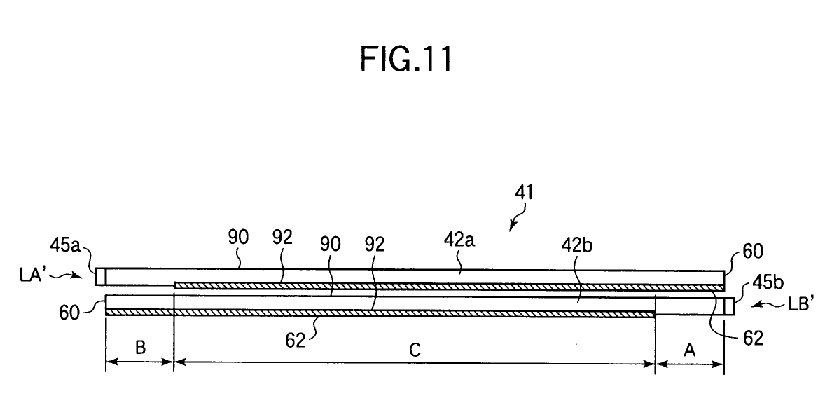

FIG. 11 shows a modification of the configuration of the light source device of the present embodiment. As shown in FIG. 11, a mirror 60 as a light-reflecting element is formed on the side end face of the light guide plate 42a opposite to the LED array LA′. Further, another mirror 60 as a light-reflecting element is formed on the side end face of the light guide plate 42b opposite to the LED array LB′.

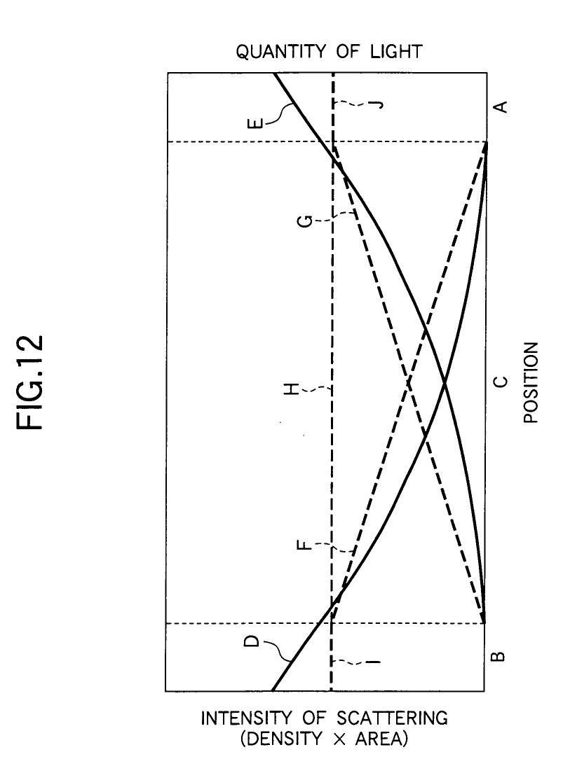

FIG. 12 is a graph showing distributions of intensities of scattering and quantities of light in the light guide plate of the present modification. The abscissa axis represents distances (positions) from the LED array LA′, and the ordinate axis represents intensities of scattering and quantities of light in the scattering layers 62. The solid line D in the graph represents the intensity of scattering in the scattering layer 62 of the light guide plate 42b, and the solid line E represents the intensity of scattering in the scattering layer 62 of the light guide plate 42a. The broken lines I and F represent the quantity of light that exits the light guide plate 42a, and the broken lines G and J represent the quantity of light that exits the light guide plate 42b. The broken lines I, H and J represent the sum of the quantity of light that exits the light guide plate 42a and the quantity of light that exits the light guide plate 42b.

As shown in FIG. 12, the quantity of light exiting the light guide plate 42a is made constant in the region B by forming the scattering layer 62 of the light guide plate 42a so that it has the scattering intensity distribution indicated by the solid line E. In the region C, the quantity of light exiting the light guide plate 42a decreases in proportion to the distance from the boundary between the regions B and C and reaches 0 at the boundary between the regions A and C. The quantity of light exiting the light guide plate 42b is made constant in the region A by forming the scattering layer 62 of the light guide plate 42b so that it has the scattering intensity distribution indicated by the solid line D. In the region C, the quantity of light exiting the light guide plate 42b decreases in proportion to the distance from the boundary between the regions A and C and reaches 0 at the boundary between the regions B and C. By distributing the quantities of light exiting the light guide plates 42a and 42b in such a manner, the sum of the quantity of light exiting the light guide plate 42a and the quantity of light exiting the light guide plate 42b is made substantially constant in a plane. In the present modification, since light rays that have reached the side end faces opposite to the LED arrays LA′ and LB′ can be reflected by the mirrors 60 to make them effective light rays, the intensity of light exiting in regions apart from the LED arrays LA′ and LB′ becomes relatively high. Therefore, the intensities of scattering in the region C can be made higher than those indicated by the solid lines D and E in FIG. 10 to achieve display with higher luminance.

### Embodiment 1-7

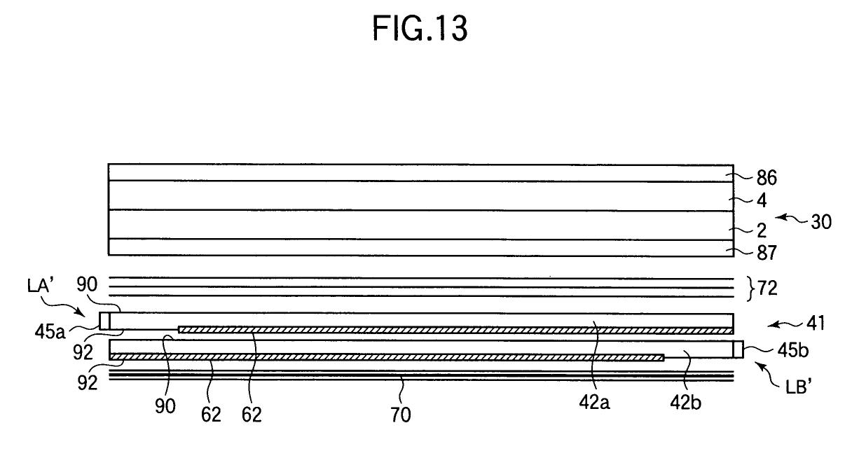

A display according to Embodiment 1-7 in the present mode for carrying out the invention will now be described with reference to FIG. 13. FIG. 13 shows a sectional configuration of the display of the present embodiment. As shown in FIG. 13, in the present embodiment, a backlight unit 41 according to Embodiment 1-6 shown in FIG. 9 is combined with a transmissive liquid crystal display panel 30. A group of light distribution sheets 72 that is a plurality of light distribution sheets for improving light distribution characteristics is provided between the liquid crystal display panel 30 and the backlight unit 41. A reflecting-scattering sheet 70 for scattering and reflecting light is provided on the opposite surface 92 of the light guide plate 42b. The present embodiment makes it possible to provide a display which is small and thin and that can achieve high display quality without irregularities of luminance and color.

### Embodiment 1-8

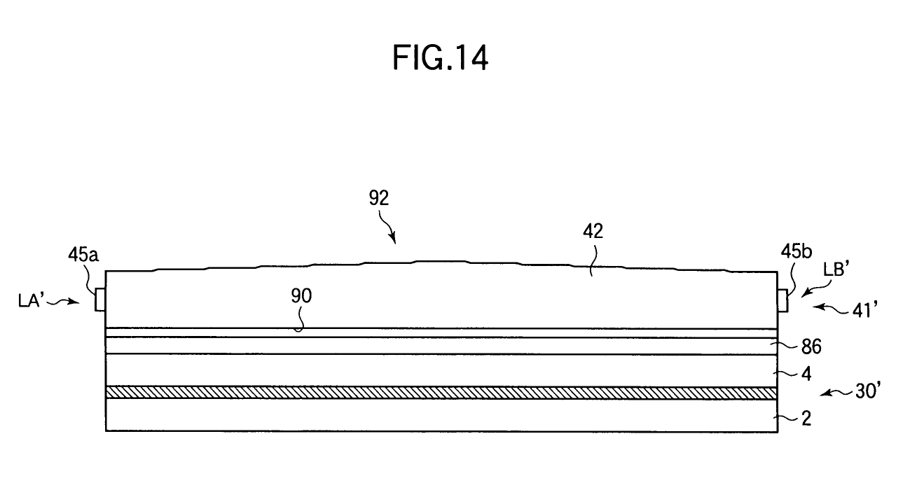

A display according to Embodiment 1-8 in the present mode for carrying out the invention will now be described with reference to FIG. 14. FIG. 14 shows a sectional configuration of the display of the present embodiment. As shown in FIG. 14, in the present embodiment, a front light unit 41′ having a configuration substantially similar to that of the backlight unit 41 according to Embodiment 1-3 shown in FIG. 6 is combined with a reflective liquid crystal display panel 30′. The present embodiment makes it possible to provide a display which is small and thin and that can achieve high display quality without irregularities of luminance and color.

### Embodiment 1-9

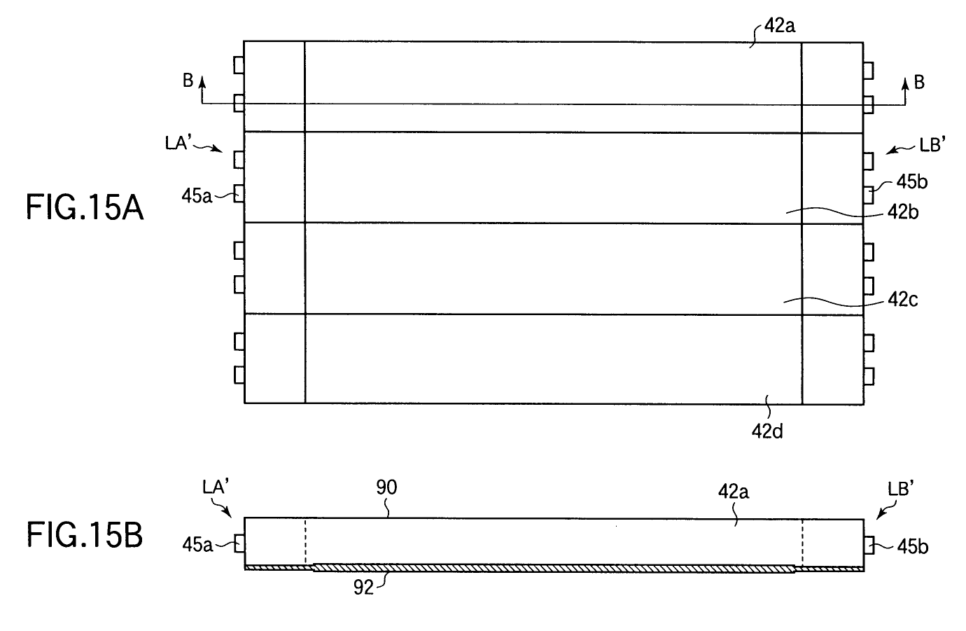

A light source device according to Embodiment 1-9 in the present mode for carrying out the invention will now be described with reference to FIGS. 15A and 15B. FIG. 15A shows a sectional configuration of the light source device of the present embodiment. FIG. 15B shows a sectional configuration of the light source device taken along the line B-B in FIG. 15A. As shown in FIGS. 15A and 15B, in the present embodiment, a backlight unit 41 has four light guide plates 42a to 42d that are optically independent of each other. The light guide plates 42a to 42d are provided such that their respective lighting areas constitute four equal divisions of a display area as a whole arranged in the vertical direction thereof. For example, a plurality of LEDs 45a constituting an LED array LA′ are arranged side by side on one side end face (a left side end face in FIGS. 15A and 15B) of each of the light guide plates 42a to 42d. Further, in a face-to-face relationship with the LED array LA′, a plurality of LEDs 45b constituting an LED array LB′ are arranged side by side on another side end face (a right side end face in FIGS. 15A and 15B) of each of the light guide plates 42a to 42d. Each of the light guide plates 42a to 42d has a region B in the vicinity of the LEDs 45a, a region A in the vicinity of the LEDs 45b, and a region C between the regions A and B. The present embodiment makes it possible to provide a light source device which is small and thin and which can achieve high display quality without irregularities of luminance and color as in Embodiment 1-1.

As described above, the present mode for carrying out the invention makes it possible to provide a light source device which is small and thin and which can achieve high display quality and to provide a display having the same.

### Second Mode for Carrying Out the Invention

Light source devices and displays having the same in a second mode for carrying out the invention will now be specifically described with reference to Embodiments 2-1 to 2-4.

### Embodiment 2-1

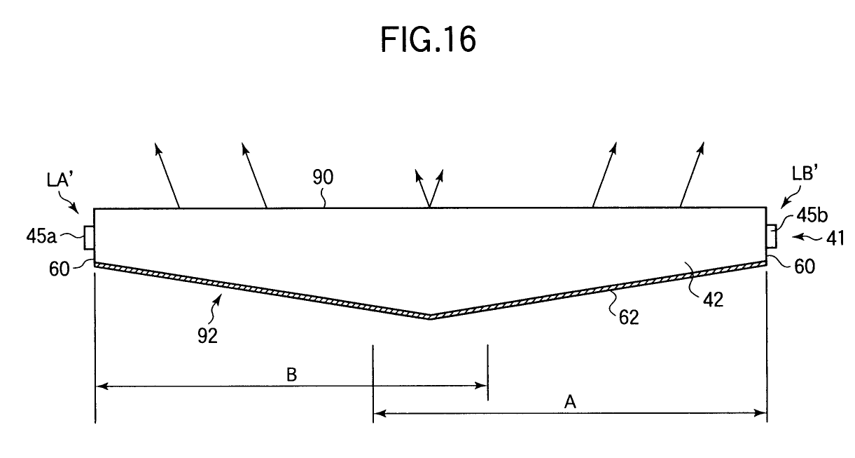

A light source device according to Embodiment 2-1 in the present mode for carrying out the invention will now be described with reference to FIG. 16. FIG. 16 shows a sectional configuration of the light source device of the present embodiment. As shown in FIG. 16, a back light unit 41 has a light guide plate 42. A plurality of LEDs 45a (only one of which is shown in FIG. 16) constituting an LED array LA′ that is an array of discrete light sources are provided side by side on one side end face of the light guide plate 42 (a left side end face in FIG. 16). A plurality of LEDs 45b (only one of which is shown in FIG. 16) constituting an LED array LB′ that is an array of discrete light sources are provided side by side on another side end face of the light guide plate 42 (a right side end face in FIG. 16) in a face-to-face relationship with the LED array LA′. The side of the light guide plate 42 where the LED array LA′ is provided is formed in a wedge-like configuration in which the thickness of the plate is smaller at the side end face and becomes greater in a central part of the same. Similarly, the side of the light guide plate 42 where the LED array LB′ is provided is formed in a wedge-like configuration in which the thickness of the plate is smaller at the side end face and becomes greater in the central part of the same. A scattering ink containing beads is applied to an opposite surface 92 of the light guide plate 42 to form a scattering layer 62 as a light-scattering element thereon.

Light from the LEDs 45a has very strong hysteresis of the discreteness of the LED array LA′ immediately after it enters a region B in the light guide plate 42, which results in irregularities in the distribution of the quantity of light that is guided. Light rays from a pair of adjoining LEDs 45a are more apt to be mixed with each other and even with light rays from other adjacent LEDs 45a, the further their positions from the LED array LA′, which results in a uniform distribution of the quantity of light guided from the side of the LED array LA′. Similarly, light from the LED array 45b has very strong hysteresis of the discreteness of the LED array LB′ immediately after it enters a region A in the light guide plate 42, which results in irregularities in the distribution of the quantity of light that is guided. Light rays from a pair of adjoining LEDs 45b are more apt to be mixed with each other and even with light rays from other adjacent LEDs 45b, the further their positions from the LED array LB′, which results in a uniform distribution of the quantity of light guided from the side of the LED array LB′.

Light rays emitted by the LEDs 45a to impinge on the light guide plate 42 are scattered by the scattering layer 62 when they are reflected at the opposite surface 92 of the light guide plate 42. However, each time the light rays are reflected, they are converged by the wedge-like feature of the light guide plate 42 to approach a direction that is in parallel with the light exit surface 90. Therefore, light guiding is sustained up to the neighborhood of a central part of the light guide plate 42 to prevent most of the light rays from exiting the light guide plate 42. After the light rays exceed the neighborhood of the central part of the light guide plate 42, they are scattered by the scattering layer 62 when reflected at the opposite surface 92 of the light guide plate 42. The angles of incidence of the light rays on the light exit surface 90 are made smaller by the wedge-like feature of the light guide plate 42 each time they are reflected, and the light rays exit the surface because the condition for total reflection is thus unsatisfied. Therefore, most of the light rays from the LED array LA′ exit the surface in the region A (a first light-emitting region) that is near the LED array LB′. Similarly, most of the light rays from the LED array LB′ exit the surface in the region B (a second light-emitting region) that is near the LED array LA′.

The backlight unit 41 has a light source driving circuit (which is not shown in FIG. 16). The light source driving circuit maximizes the intensity of light rays emitted by the LEDs 45a of the LED array LA′ and the intensity of light rays emitted by the LEDs 45b of the LED array LB′ at different timing. For example, by flashing those arrays with a timing shift of 8.4 msec (which is equivalent to a ½ period) from each other, flashing illumination at a flashing frequency of 60 Hz can be performed to flash parts of a light-emitting region alternately, each part occupying substantially a half of the region.

While the combination of the scattering layer 62 and the wedge-like feature of the light guide plate 42 is used as a lighting element in the present embodiment, prism-like features constituted by prism surfaces 50 and 51 formed on the opposite surface 92 of the light guide plate 42 may alternatively be used as lighting elements. Since the prism-like features reflect or refract light rays from the direction toward which the prism surfaces 50 and 51 are faced, selective lighting can be performed in the same manner as described above.

In the present embodiment, the LED array LA′ and the region A where light rays from the side of the LED array LA′ are taken out are spaced from each other a relatively great distance, and the LED array LB′ and the region B where light rays from the side of the LED array LB′ are taken out are spaced from each other a relatively great distance. Therefore, the light rays exit the light exit surface 90 after being sufficiently mixed to distribute the quantity of the guided light uniformly, which makes it possible to provide a light source device that achieves high display quality without irregularities of luminance and color. In the present embodiment, the LEDs 45a are provided near the region B of the light guide plate 42, and the LEDs 45b are provided near the region A of the light guide plate 42. This makes it possible to provide a small and thin light source device.

### Embodiment 2-2

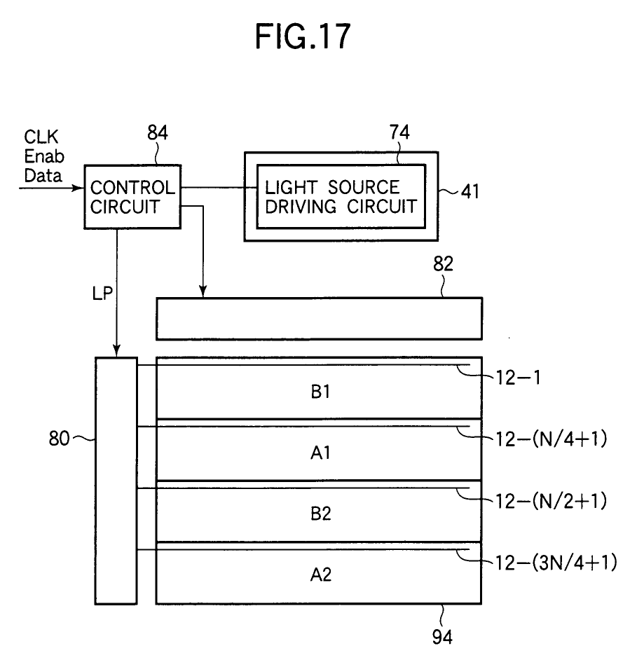

A light source device and a display having the same according to Embodiment 2-2 in the present mode for carrying out the invention will now be described with reference to FIGS. 17 to 20. FIG. 17 is a block diagram showing a configuration of a liquid crystal display of the present embodiment. As shown in FIG. 17, the liquid crystal display has a backlight unit 41, a control circuit 84 and a driving circuit constituted by a gate bus line driving circuit 80 and a drain bus line driving circuit 82. The backlight unit 41 has a light source driving circuit 74. The light source driving circuit 74 is connected to the control circuit 84. A clock CLK, a data enable signal Enab and tone data Data output from a system such as a personal computer are input to the control circuit 84. The control circuit 84 has a frame memory (not shown) for storing image signals for one frame. The gate bus line driving circuit 80 and the drain bus line driving circuit 82 are connected to the control circuit 84. For example, the gate bus line driving circuit 80 has a shift register, and it receives a latch pulse LP from the control circuit 84 and sequentially outputs gate pulses to perform line sequential driving starting with a line where display is to be started.

The liquid crystal display has N gate bus lines 12-1 to 12-N (only four of which are shown in FIG. 17) in its display area 94. The gate bus lines 12-1 to 12-N are connected to the gate bus line driving circuit 80. The display area 94 are divided into four regions B1, A1, B2 and A2 which have substantially equal areas and which extend in parallel with the gate bus lines 12. The gate bus lines 12-1 to 12-(N/4) are provided in the region B1. The gate buslines 12-(N/4+1)to 12-(N/2) are provided in the region A1. The gate bus lines 12-(N/2+1) to 12-(3×N/4) are provided in the region B2. The gate bus lines 12-(3×N/4+1) to 12-N are provided in the region A2.

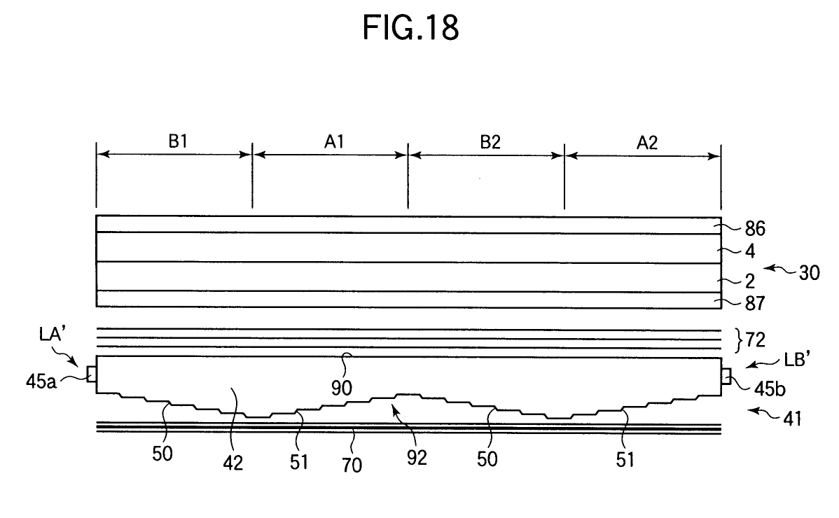

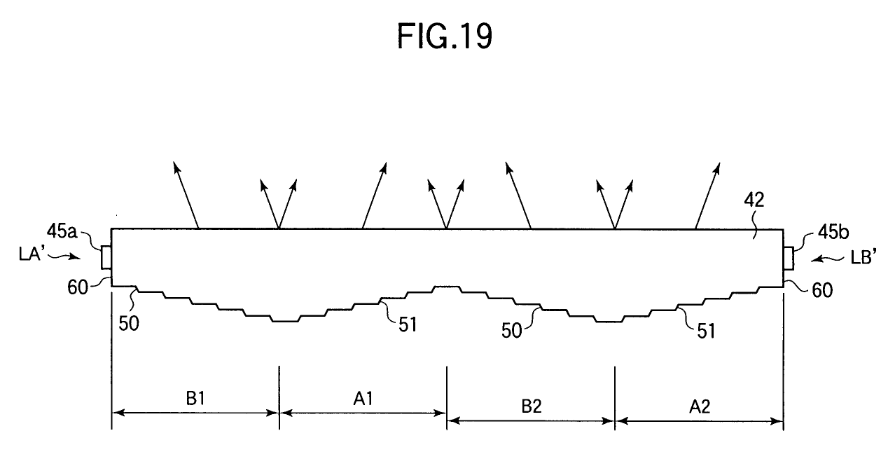

FIG. 18 shows a sectional configuration of the liquid crystal display of the present embodiment. FIG. 19 shows a sectional configuration of the light source device of the present embodiment. As shown in FIGS. 18 and 19, the liquid crystal display has a transmissive liquid crystal display panel 30 and a backlight unit 41. A lighting area of the light guide plate 42 is divided into four regions, i.e., regions B1, A1, B2 and A2. The opposite surface 92 of the light guide plate 42 is formed with prism-like features. The prism-like features on the opposite surface 92 are used lighting elements.

The opposite surface 92 in the regions B1 and B2 is in the form of such prisms that light rays from the side of the LED array LA′ are directly guided toward the LED array LB′ without impinging on prism surfaces 50. The prism surfaces 50 are formed at an inclination in the range from 40° to 45° to a light exit surface 90, for example. On the contrary, light rays from the side of the LED array LB′ impinge on the prism surfaces 50 with certain probabilities. The light rays incident on the prism surfaces 50 exit the light guide plate 42 as a result of reflection or refraction because the condition for total reflection is unsatisfied. Therefore, light rays guided from the side of the LED array LB′ are basically taken out in the regions B1 and B2. The light rays guided from the side of the LED array LB′ include not only light rays directly emitted by the LEDs 45b but also reflected light rays which have been emitted by the LEDs 45a and reflected on the side end face of the light guide plate 42 where the LEDs 45b are provided.

The opposite surface 92 in the regions A1 and A2 is in the form of such prisms that light rays from the side of the LED array LB′ are directly guided toward the LED array LA′ without impinging on prism surfaces 51. On the contrary, light rays from the side of the LED array LA′ impinge on the prism surfaces 51 with certain probabilities. The light rays incident on the prism surfaces 51 exit the light guide plate 42 as a result of reflection or refraction because the condition for total reflection is unsatisfied. Therefore, light rays guided from the side of the LED array LA′ are basically taken out in the regions A1 and A2. As apparent from above, the light guide plate 42 has a sectional shape that is laterally symmetric. The regions A1 and A2 where the light rays guided from the side of the LED array LA′ are taken out (a first light-emitting region) and the regions B1 and B2 where the light rays guided from the side of the LED array LB′ are taken out (a second light-emitting region) are alternatively arranged.

A group of light distribution sheets 72 that is a plurality of light distribution sheets for improving light distribution characteristics is provided between the liquid crystal display panel 30 and the backlight unit 41. A reflecting-scattering sheet 70 for scattering and reflecting light is provided on the opposite surface 92 of the backlight unit 41.

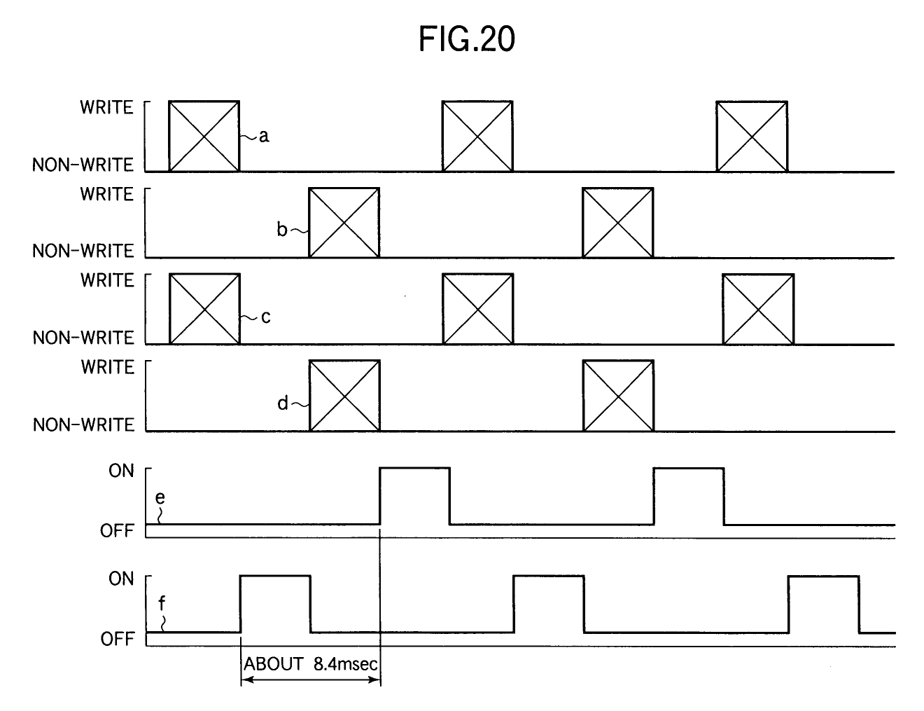

FIG. 20 illustrates a method for driving the light source device and the display having the same of the present embodiment. Time is represented in the direction of the abscissa axis, and states of writing of tone data (write and non-write states) and states of flashing (on and off states) of the backlight unit 41 are represented in the direction of the ordinate axis. The waveform a represents a state of writing of tone data in the region B1, and the waveform b represents a state of writing of tone data in the region A1. The waveform c represents a state of writing of tone data in the region B2, and the waveform d represents a state of writing of tone data in the region A2. The waveform e represents a state of flashing of the LED array LB′, and the waveform f represents a state of flashing of the LED array LA′. As shown in FIG. 20, the light source driving circuit 74 causes the LEDs 45a and 45b of the respective LED arrays LA′ and LB′ to emit light at a flashing frequency that is equal to a frame frequency (e.g., 60 Hz) for a predetermined time in synchronism with the latch pulse LP. The light source driving circuit 74 maximizes the intensity of light emitted by the LEDs 45a of the LED array LA′ at timing that is about 8.4 msec (a ½ period) different from the timing at which the intensity of light emitted by the LEDs 45b of the LED array LB′ is maximized.

Tone data are written in pixels in the light-emitting regions B1 and B2 at substantially the same timing. The liquid crystal display of the present embodiment is of the multi-scan type, and the gate bus line driving circuit 80 outputs gate pulses to the gate bus lines 12-1, 12-(N/2+1), 12-2, 12-(N/2+2), and so on, in the order listed. That is, the gate bus lines 12 in the light-emitting regions B1 and B2 are alternately scanned. A gate pulse is output to the gate bus line 12-(N/4+1) a ½ period after a gate pulse is output to the gate bus line 12-1, the gate bus lines 12-(3×N/4+1), 12-(N/4+2), 12-(3×N/4+2), and so on are scanned in that order.

When a predetermined time has passed after the writing of tone data in the pixels in the regions B1 and B2, the LEDs 45b of the LED array LB′ are turned on to cause emission of light in the regions B1 and B2. After the LEDs 45b of the LED array LB′ are turned off, tone data are written in the pixels in the regions B1 and B2. Similarly, when a predetermined time has passed after the writing of tone data in pixels in the regions A1 and A2, the LEDs 45a of the LED array LA′ are turned on to cause emission of light in the regions A1 and A2. After the LEDs 45a of the LED array LA′ are turned off, tone data are written in the pixels in the regions A1 and A2. As thus described, the LEDs for a region is off while tone data are written in the region. In the case of a liquid crystal display, since it takes a time in the range from several milliseconds to several tens milliseconds for liquid crystal molecules to be tilted at a predetermined tilt angle after tone data are written in pixels, high display quality of dynamic images can be achieved by putting as much time as possible before LEDs are turned on after the tone data are written. For this reason, writing (rewriting) of tone data is started immediately after LEDs are turned off in the present embodiment.

The present embodiment makes it possible to achieve high display quality even in displaying a dynamic image without a blur on contours as well as the same advantage as that of Embodiment 2-1. In the present embodiment, the thickness of the light source device can be kept small because it has only one light guide plate 42.

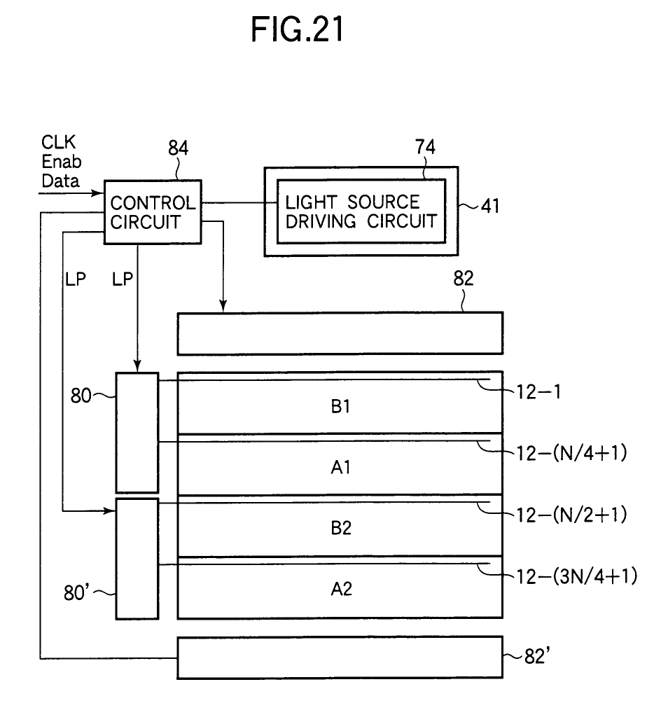

FIG. 21 is a block diagram showing a modification of the configuration of the liquid crystal display of the present embodiment. As shown in FIG. 21, in the present modification, a gate bus line driving circuit 80 for driving gate bus lines 12-1 to 12-(N/2) in regions B1 and A1 and a gate bus line driving circuit 80′ for driving gate bus lines 12-(N/2+1) to 12-N in regions B2 and A2 are provided independently of each other. The gate bus line driving circuits 80 and 80′ are connected to a control circuit 84. At the same time when the gate bus line driving circuit 80 applies a gate voltage to the gate bus line 12-1, the gate bus line driving circuit 80′ applies a gate voltage to the gate bus line 12-(N/2+1). Thus, in the present modification, at the same time when the gate bus line driving circuit 80 scans the gate bus lines 12-1, 12-2, . . . 12-(N/2) in the order listed, the gate bus line driving circuit 80′ can scan the gate bus lines 12-(N/2+1), 12-(N/2+2), . . . 12-N in the order listed. The present modification also provides the same advantages as those of the above-described embodiment.

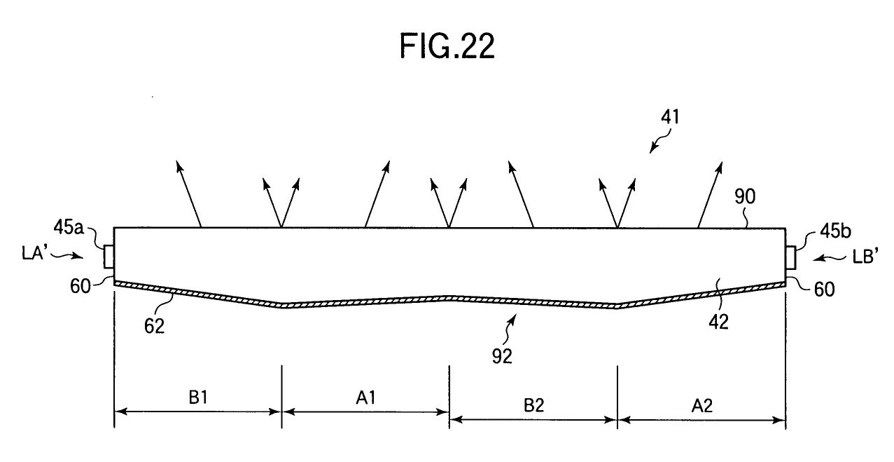

FIG. 22 is a sectional view showing a modification of the configuration of the light source device of the present embodiment. In the present modification, as shown in FIG. 22 a scattering layer 62 formed on the opposite surface 92 and wedge-like features of the light guide plate 42 are used as lighting elements instead of the prism-like features on the opposite surface 92 of the light guide plate 42. The present modification also provides the same advantages as the above-described embodiment.

### Embodiment 2-3

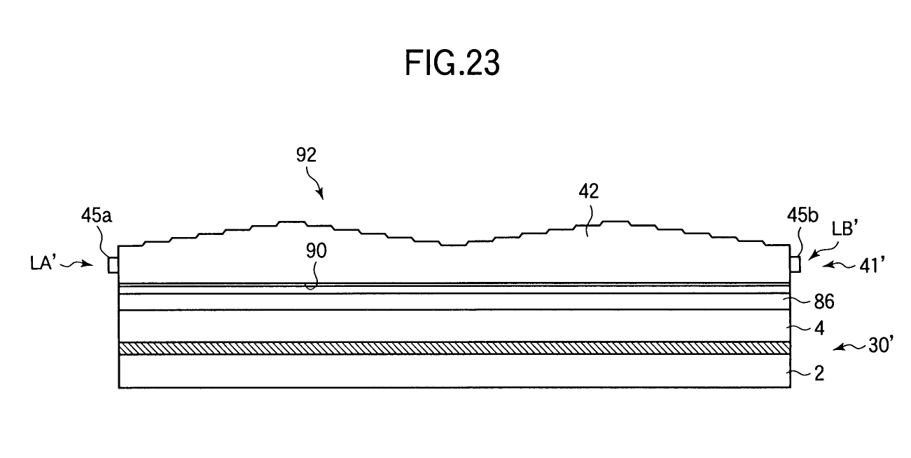

A display according to Embodiment 2-3 in the present mode for carrying out the invention will now be described with reference to FIG. 23. FIG. 23 shows a sectional configuration of the display of the present embodiment. As shown in FIG. 23, in the present embodiment, a front light unit 41′ having a configuration substantially similar to the backlight unit 41 of Embodiment 2-2 shown in FIG. 19 is combined with a reflective liquid crystal display 30′. The present embodiment makes it possible to provide a display which is small and thin and which can achieve high display quality without irregularities of luminance and color.

### Embodiment 2-4

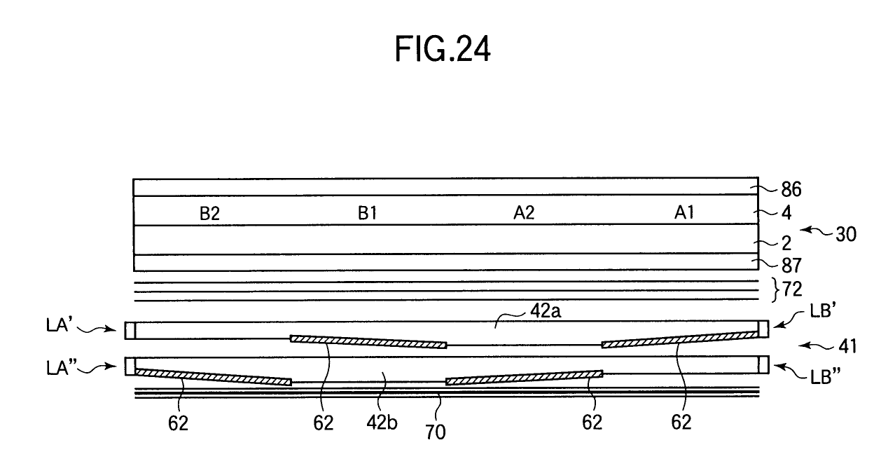

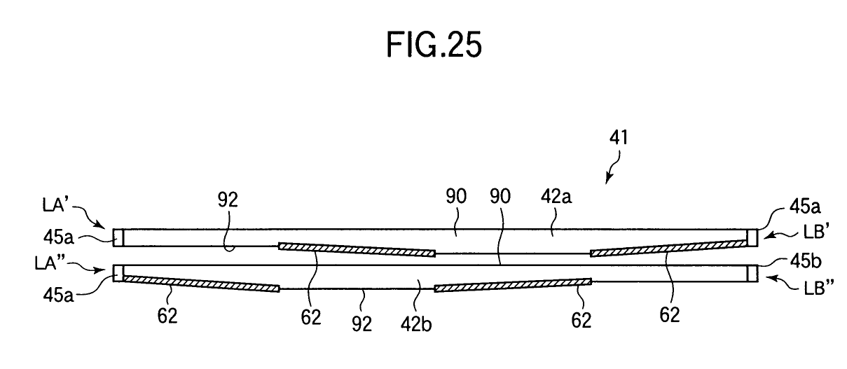

A light source device and a display having the same according to Embodiment 2-4 in the present mode for carrying out the invention will now be described with reference to FIGS. 24 to 26. FIG. 24 shows a sectional configuration of a liquid crystal display of the present embodiment. FIG. 25 shows a sectional configuration of the light source device of the present embodiment. As shown in FIGS. 24 and 25, a backlight unit 41 of the present embodiment has two light guide plates 42a and 42b which are stacked one on the other. Lighting areas of the light guide plates 42a and 42b are divided into four regions, i.e., regions A1, A2, B1 and B2. A plurality of LEDs 45a constituting an LED array LA′ are provided side by side on one side end face (a left side end face in FIGS. 24 and 25) of the light guide plate 42a. A plurality of LEDs 45b constituting an LED array LB′ are provided side by side on another side end face (a right side end face in FIGS. 24 and 25) of the light guide plate 42a. In the region B1, the light guide plate 42a is formed with a wedge-like feature in which an opposite surface 92 of the same is inclined relative to a light exit surface 90 such that the thickness of the plate is smaller on the side of the LED array LA′ and greater on the side of the LED array LB′. In the region A1, the light guide plate 42a is formed with a wedge-like feature in which the opposite surface 92 is inclined relative to the light exit surface 90 such that the thickness of the plate is greater on the side of the LED array LA′ and smaller on the side of the LED array LB′. Light-scattering layers 62 that are light-scattering elements are formed on the opposite surface 92 in the regions A1 and B1. The light guide plate 42a has a light guide region for guiding light from the side of the LED array LA′ to the region A1 and a light guide region for guiding light from the side of the LED array LB′ to the region B1.

A plurality of LEDs 45a constituting an LED array LA″ are provided side by side on one side end face (a left side end face in FIGS. 24 and 25) of the light guide plate 42b. A plurality of LEDs 45b constituting an LED array LB″ are provided side by side on another side end face (a right side end face in FIGS. 24 and 25) of the light guide plate 42b. In the region B2, the light guide plate 42b is formed with a wedge-like feature in which an opposite surface 92 of the same is inclined relative to a light exit surface 90 such that the thickness of the plate is smaller on the side of the LED array LA″ and greater on the side of the LED array LB″. In the region A2, the light guide plate 42b is formed with a wedge-like feature in which the opposite surface 92 is inclined relative to the light exit surface 90 such that the thickness of the plate is greater on the side of the LED array LA″ and smaller on the side of the LED array LB″. Scattering layers 62 that are light-scattering elements are formed on the opposite surface 92 in the regions A2 and B2. The light guide plate 42b has a light guide region for guiding light from the side of the LED array LA″ to the region A2 and a light guide region for guiding light from the side of the LED array LB″ to the region B2.

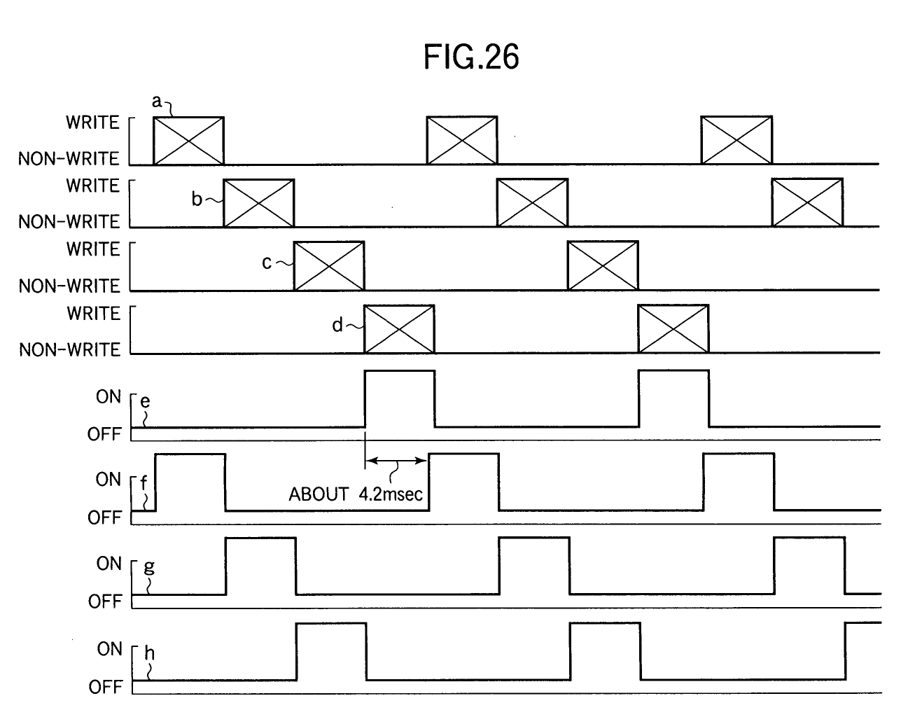

FIG. 26 illustrates a method for driving the light source device and the display having the same of the present embodiment. Time is represented in the direction of the abscissa axis, and states of writing of tone data (write and non-write states) and states of flashing (on and off states) of the backlight unit 41 are represented in the direction of the ordinate axis. The waveform a represents a state of writing of tone data in the region A1, and the waveform b represents a state of writing of tone data in the region A2. The waveform c represents a state of writing of tone data in the region B1, and the waveform d represents a state of writing of tone data in the region B2. The waveform e represents a state of flashing of the LED array LA′, and the waveform f represents a state of flashing of the LED array LA″. The waveform g represents a state of flashing of the LED array LB′, and the waveform h represents a state of flashing of the LED array LB″.

As shown in FIG. 26, a light source driving circuit 74 (which is not shown in FIG. 24) causes the LEDs 45a and 45b of the respective LED arrays LA′, LA″, LB′ and LB″ to emit light at a flashing frequency that is equal to a frame frequency (e.g., 60 Hz) for a predetermined time in synchronism with the latch pulse LP. The light source driving circuit 74 maximizes the intensity of light emitted by the LEDs 45a of the LED array LA′ at timing that is about 4.2 msec (a ¼ period) different from the timing at which the intensity of light emitted by the LEDs 45a of the LED array LA″ is maximized. Similarly, timing for maximizing the intensity of light emitted by the LEDs 45a of the LED array LA″ is about 4.2 msec different from timing for maximizing the intensity of light emitted by the LEDs 45b of the LED array LB′. Timing for maximizing the intensity of light emitted by the LEDs 45b of the LED array LB′ is about 4.2 msec different from timing for maximizing the intensity of light emitted by the LEDs 45b of the LED array LB″. Timing for maximizing the intensity of light emitted by the LEDs 45b of the LED array LB″ is about 4.2 msec different from timing for maximizing the intensity of light emitted by the LEDs 45a of the LED array LA′.

When a predetermined time has passed after the writing of tone data in pixels in the region A1, the LEDs 45a of the LED array LA′ are turned on to cause emission of light in the region A1. After the LEDs 45a of the LED array LA′ are turned off, tone data are written in the pixels in the region A1. When a predetermined time has passed after the writing of tone data in pixels in the region A2, the LEDs 45a of the LED array LA″ are turned on to cause emission of light in the region A2. After the LEDs 45a of the LED array LA″ are turned off, tone data are written in the pixels in the region A2. Similarly, when a predetermined time has passed after the writing of tone data in pixels in the region B1, the LEDs 45b of the LED array LB′ are turned on to cause emission of light in the region B1. After the LEDs 45b of the LED array LB′ are turned off, tone data are written in the pixels in the region B1. When a predetermined time has passed after the writing of tone data in pixels in the region B2, the LEDs 45b of the LED array LB″ are turned on to cause emission of light in the region B2. After the LEDs 45b of the LED array LB″ are turned off, tone data are written in the pixels in the region B2.

As thus described, the LEDs for a region is off while tone data are written in the region. In the case of a liquid crystal display, since it takes a time in the range from several milliseconds to several tens milliseconds for liquid crystal molecules to be tilted at a predetermined tilt angle after tone data are written in pixels, high display quality of dynamic images can be achieved by putting as much time as possible before LEDs are turned on after the tone data are written. For this reason, writing (rewriting) of tone data is started immediately after LEDs are turned off in the present embodiment. The present embodiment makes it possible to achieve high display quality even in displaying a dynamic image without a blur on contours as well as the same advantage as that of Embodiment 2-1. Unlike Embodiment 2-2, the present embodiment results in no increase in the complexity of a driving circuit because there is no need for a multi-scan type liquid crystal display.

As described above, in the present mode for carrying out the invention, it is easy to provide a scan-type light source device utilizing an array of discrete light sources such as LEDs and a display having the same. In the present mode for carrying out the invention, it is possible to provide a compact, thin, and narrow-framed display and to provide a display which has a wide range of color reproduction, which provides dynamic images of high quality without a blur on contours, and which has uniform luminance and colors.

The invention is not limited to the above embodiments and may be modified in various ways.

For example, while active matrix type liquid crystal displays have been described as examples in the above modes for carrying out the invention, the invention may be applied to simple matrix type liquid crystal displays.

A lighting area of a light guide plate 42 is divided into two or four regions in the above modes for carrying out the invention. This is not limiting the invention, and any number of divisions may be provided.

While TN mode liquid crystal displays have been described as examples in the above modes for carrying out the invention, the invention is not limited to them and may be applied to liquid crystal displays of other modes such as the MVA mode and IPS mode.

As described above, the invention makes it possible to provide a light source device that is small, thin and capable of achieving high display quality and a display having the same.

What is claimed is:

1. A light source device comprising:
first and second light sources which emit light; and
a planar light guide plate having a first light-emitting region which is provided in an area other than the neighborhood of the first light source and which has a first lighting element for taking out light guided from the side of the first light source and a second light-emitting region which is provided in an area other than the neighborhood of the second light source and which has a second lighting element for taking out light guided from the side of the second light source.

2. A light source device according to claim 1, wherein the first and second lighting elements include a prism-like feature formed on a surface of the planar light guide plate.

3. A light source device according to claim 1, wherein the first and second lighting elements include a light-scattering element formed on a surface of the planar light guide plate.

4. A light source device according to claim 1, wherein the planar light guide plate has light-reflecting elements for reflecting light on end faces thereof which are opposite to the first and second light sources, respectively.

5. A light source device according to claim 1, wherein each of the first and second light sources is a plurality of point light sources which are provided side by side.

6. A light source device according to claim 1, wherein the first light source is provided near the second light-emitting region and wherein the second light source is provided near the first light-emitting region.

7. A light source device according to claim 1, further comprising:
a first light guide region for guiding light from the side of the first light source to the first light-emitting region; and
a second light guide region for guiding light from the side of the second light source to the second light-emitting region;
wherein the first and second light guide regions are provided in the single planar light guide plate.

8. A light source device according to claim 1, further comprising:
a first light guide region for guiding light from the side of the first light source to the first light-emitting region; and
a second light guide region for guiding light from the side of the second light source to the second light-emitting region;
wherein the first and second light guide regions are provided in each of a couple of the planar light guide plates which are stacked one on the other.

9. A light source device according to claim 1, further comprising a light source driving circuit for causing the first and second light sources to emit light at a predetermined flashing frequency at predetermined timing which is different between the light sources.

10. A light source device according to claim 1, wherein the first and second light-emitting regions are divided into respective plural parts which are alternately arranged.

11. A light source device according to claim 1, wherein the first and second lighting elements include a wedge-like feature of the planar light guide plate.

12. A light source device according to claim 1, wherein a plurality of the planar light guide plates are provided such that they are optically independent of each other.

13. A display comprising:
a display panel having a display area including a plurality of pixels;
a driving circuit for supplying a predetermined drive signal to the display panel; and
a light source device for illuminating the display panel;
wherein the light source device is a light source device according to claim 1.

14. A display according to claim 13, wherein the display panel is a liquid crystal display panel having a pair of substrates and a liquid crystal sealed between the pair of substrates.

15. A display according to claim 13, wherein the first and second light-emitting regions are arranged in a direction in which the display area is scanned.

16. A display according to claim 13, wherein the flashing frequency is equal to a frame frequency of the display panel.

17. A display according to claim 13, wherein the driving circuit performs multi-scan by supplying the driving signal to the display panel in synchronism with said timing.
